(19) United States
(12) Patent Application Publication
(10) Pub. No.: US 2005/0138853 A1
(43) Pub. Date: Jun. 30, 2005

(54) Ornamental panel with an adhesive layer

(76) Inventor: Yen-Ho Chiang, Fengshan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/744,010

(22) Filed: Dec. 24, 2003

(51) Int. Cl. G09F 7/12; G09F 7/04

(52) U.S. Cl. 40/594; 40/600

(57) ABSTRACT

An ornamental panel includes a primary plate, an adhesive layer formed over a front side of the primary plate, a protecting film detachably stuck on the adhesive layer, and a magnet plate attached to a rear side of the primary plate; the adhesive layer has such a stickiness that a piece of paper can be stuck thereon, and detached from it without causing any damage to itself or the adhesive layer; the panel can be attached to a refrigerator or a steel cupboard at the magnet plate thereof for holding notes, posters, drawings etc. in position with the adhesive layer thereof.

### BACKGROUND OF THE INVENTION

1. Field of the invention

The present invention relates to an ornamental panel, which can be detachably attached a piece of furniture made of metal materials such as a refrigerator or cupboard ; more particularly, this invention is formed with such an adhesive layer on a front side for allowing certain objects, e.g. notes, drawings, messages, and posters, to be detachably attached thereto.

2. Brief Description of the Prior Art

Some people would attach drawings and posters to a refrigerator, cupboard or other furniture by means of glue or magnets for the ornamental purpose. Among the means, tearing a glued drawing or poster 81 off a refrigerator may leave the traces of glue or scraps of paper. Referring to FIG. 5, people can also make the drawing or poster 81 attached in a single position by the attraction arisen between a magnet 80 and the metal furniture.

However, the attracted drawing or poster is prone to fall away from the furniture when wind blows on it or people's hands hit it unintentionally.

### SUMMARY OF THE INVENTION

It is a main objective of the present invention to provide a panel, with which drawings, notes, and posters can be detachable and easily held in position on a piece of furniture made of metal, to overcome the above disadvantage.

The ornamental panel includes a primary plate, an adhesive layer formed over a front side of the primary plate, a protecting film detachably stuck on the adhesive layer, and a magnet plate attached to the rear side of the primary plate. The adhesive layer has such stickiness that allows a piece of paper to be stuck thereon, and detached therefrom without causing any damage to itself or the adhesive layer. Thus, the panel can be attached to a refrigerator or metal cupboard for holding notes or posters in position with the adhesive layer thereof.

### BRIEF DESCRIPTION OF THE DRAWINGS

The present invention will be better understood by referring to the accompanying drawings, wherein:

FIG. 1 is an exploded perspective view of the ornamental panel according to the present invention,

FIG. 2 is a perspective view of the ornamental panel according to the present invention,

FIG. 3 is a view showing the use of an ornamental panel of the second embodiment,

FIG. 4 is a view showing the use of an ornamental panel of the third embodiment, and

FIG. 5 is a view illustrating the method for attaching a poster to a refrigerator as described in the Background.

### DETAILED DESCRIPTION OF THE PREFERRED EMBODIMENTS

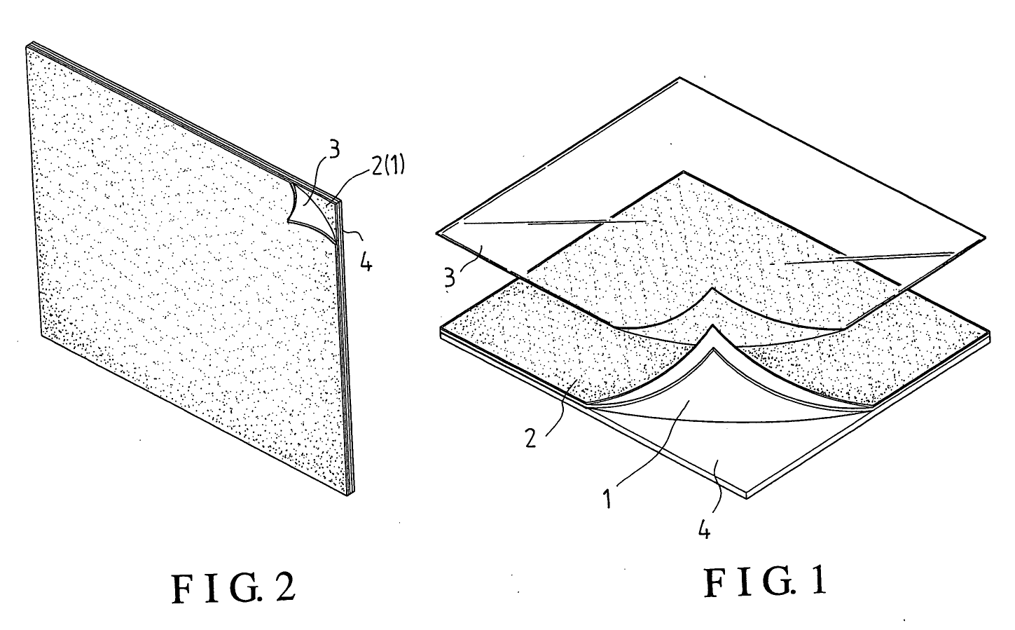

Referring to FIG. 1, a preferred embodiment of an ornamental panel in the present invention includes:
a primary plate 1, the primary plate 1 is watertight, strong, and preferably plastic synthetic paper used for the purpose of the environment protection and can't be spoiled by high humidity; more particularly, it is best to use plastic synthetic paper that is made of PP and PS as the primary plate 1 because any burning of PP and PS won't produce toxic substances;
an adhesive layer 2 formed over the front side of the primary plate 1; the adhesive layer 2 is made of water-based glue mixed with release agent to have such a stickiness that a piece of paper can be firmly stuck thereon, and easily detached therefrom without causing any damage to itself or the adhesive layer 2;
a film 3 is stuck on the adhesive layer 2 for protecting same before the present ornamental panel comes into use; the film 3 has to be detached from the adhesive layer 2 for allowing same to be used; and
a magnet plate 4 is stuck on a rear side of the primary plate 1; the magnet plate 4 can be attached to the primary plate 1 by means of hot melt or high frequency.

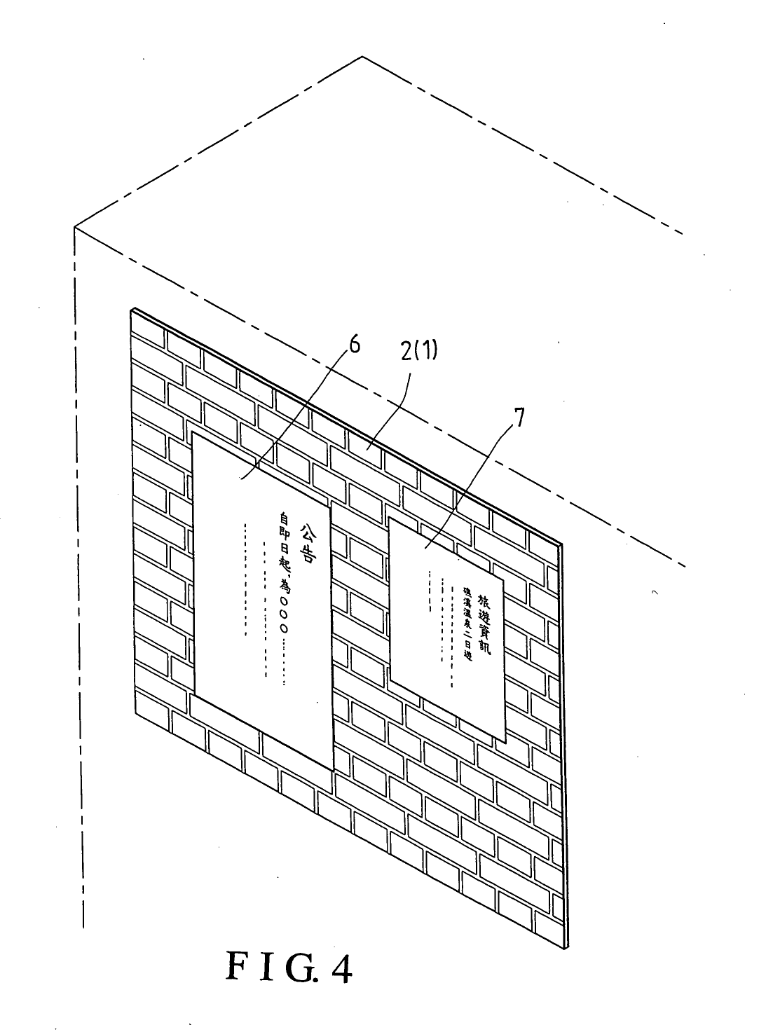

Thus, the present panel can be attached to a refrigerator, cupboard or other furniture made of metal materials by the attraction arisen from the magnet plate 4, and then the message sheet 7, the bulletin 6, other drawings, notes or posters can be stuck on the adhesive layer 2 as shown in FIG. 4, and easily detached from the adhesive layer 2 without causing damage to themselves or the adhesive layer 2.

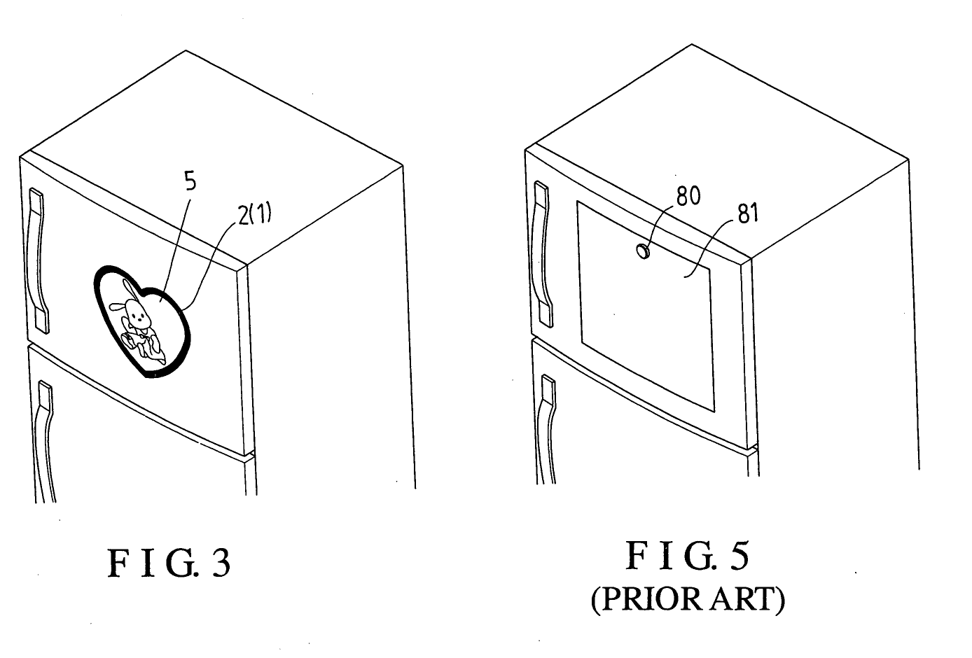

In addition, ornamental panels of various shapes, e.g. a heart-shape as shown FIG. 3, a rectangle, or a star, can be provided for providing the consumers with more options in the present invention. And, referring to FIG. 4, another embodiment of an ornamental panel in the present invention includes a primary plate 1 formed with ornamental patterns and drawings on a front side; further, a transparent adhesive layer 2 formed over the front side of the primary plate 1, a transparent film (not shown) for protecting the adhesive layer 2, and a magnet plate (not shown) on the rear side of the primary plate 1; thus, the patterns on the primary plate 1 can be seen through the adhesive layer 2 and the film 3, and the panel is attractive.

From the above description, it can be understood easily that the ornamental panel of the present invention has advantages as followings:
1. The present panel can be easily held in position on a piece of metal furniture or a refrigerator owing to the magnet plate 4 thereof. Also, posters pressed lightly against the adhesive layer 2 can be attached to the present panel. Therefore, the panel is convenient to use.
2. Posters etc. can be easily detached from the adhesive layer 2 without causing damage to themselves or the adhesive layer 2. Therefore, the panel can be used over and over again.
3. The present panel can make a large poster or drawing firmly held in position thereon because the adhesive layer 2 allows a large proportion of the poster (drawing) to come into contact therewith for the purpose of the stability.
4. Ornamental panels of the present invention are provided in various shapes, and formed with patterns thereon to be attractive alone and satisfy the consumers' need for variety.
5. Consumers can easily see the patterns on the primary plate when shopping because the protective film and the adhesive layer are transparent.
6. The primary plate has long life length in using because it is made of plastic synthetic paper, which is watertight, strong, and can't be spoiled by high humidity.
7. There are no toxic substances produced from burning PP and PS, which are used as the materials for primary plates 1. Therefore, the primary plates made of plastic synthetic paper are beneficial to protect our environment.

1. An ornamental panel, comprising
a primary plate;
an adhesive layer formed over the front side of the primary plate;
a protecting film detachably stuck on the adhesive layer; and
a magnet plate attached to the rear side of the primary plate;
the adhesive layer having such a stickiness that a piece of paper can be stuck thereon, and detached therefrom without causing any damage to itself.

2. The ornamental panel as claimed in claim 1, wherein the primary plate is plastic synthetic paper.

3. The ornamental panel as claimed in claim 2, wherein the primary plate is made of PP.

4. The ornamental panel as claimed in claim 2, wherein the primary plate is made of PS.

5. The ornamental panel as claimed in claim 1, wherein the primary plate is formed with patterns on the front side thereof.

6. The ornamental panel as claimed in claim 1, wherein the primary plate is formed with drawings on the front side thereof.

7. The ornamental panel as claimed in claim 1, wherein both the adhesive layer and the protecting film are transparent.

8. The ornamental panel as claimed in claim 1, wherein the adhesive layer is made of hydrated glue mixed with the release agent.

9. The ornamental panel as claimed in claim 1, wherein the magnet plate is attached to the primary plate by means of hot melt.

10. The ornamental panel as claimed in claim 1, wherein the magnet plate is attached to the primary plate by means of high frequency.
